(19) United States
(12) Patent Application Publication
(10) Pub. No.: US 2009/0067658 A1
(43) Pub. Date: Mar. 12, 2009

(54) PORTABLE OVER-THE-EAR MINIATURE SOUND BOX DEVICE

(76) Inventor: Hsien Cheng Lin, Taipei City (TW)

Correspondence Address: SINORICA, LLC, 528 FALLSGROVE DRIVE, ROCKVILLE, MD, 20850, US

(21) Appl. No.: 11/953,067

(22) Filed: Dec. 9, 2007

(30) Foreign Application Priority Data
Sep. 6, 2007 (TW) 096133199
Oct. 2, 2007 (TW) 096216425

(51) Int. Cl. H04R 1/02; H04R 25/00

(52) U.S. Cl. 381/345; 381/381

(57) ABSTRACT

A portable over-the-ear miniature sound box device comprises a loudspeaker, a first chamber and a second chamber. The loudspeaker is located in the first chamber. A first sound output hole of the first chamber is connected with a sound-receiving hole of the second chamber. A second sound output hole is disposed at the opposite side of the sound-receiving hole of the second chamber. A sound signal first resonates in the loudspeaker and is then sent through the first chamber to second chamber. Sound resonates again in the second chamber and is finally sent out via the second sound output hole. Because the sound signal resonates twice and is more convergent and the first resonance occurs in the loudspeaker, the bass will be thicker and more easily heard by human ears, hence solving the problem of easy divergence of the bass.

### BACKGROUND OF THE INVENTION

1. Field of the Invention

The present invention relates to an earphone structure and, more particularly, to a portable over-the-ear miniature sound box device.

2. Description of Related Art

Along with the continual development of network, resource interchange becomes more and more frequent, and music files can be easily downloaded into personal computers from network. Collocated with the recent trend of walkmans, people can store music into a walkman and then listen to music when they ride, walk, or wait for the bus or train. However, because an earphone matched with a walkman has a small size, its resonance chamber also is small. Therefore, the bass usually diverges during transmission of sound.

FIG. 1 is a side cross-sectional view of a prior art miniature earphone. As shown in FIG. 1, the earphone comprises a loudspeaker 10, a first space 12, a second space 14 and a sound guiding pipe 16. After the loudspeaker 10 emits out sound, sound waves resonate in the first space 12 and the second space 14 and are finally transmitted into a human ear via the sound guiding pipe 16. Although the prior art earphone has two resonance chambers (i.e., the first space 12 and the second space 14), this structure is still deficient in the convergence of the bass because of the divergence property of the bass.

Accordingly, the present invention aims to provide a portable over-the-ear miniature sound box device to solve the above problems in the prior art.

### SUMMARY OF THE INVENTION

An object of the present invention is to provide a portable over-the-ear miniature sound box device, which allows a sound signal to resonate twice to become more convergent. Moreover, because the first resonance occurs in the loudspeaker, the bass will be thicker and more easily heard by human ears, hence solving the problem of easy divergence of the bass.

Another object of the present invention is to provide a portable over-the-ear miniature sound box device, which makes use of a loudspeaker with a resonance effect so that sound waves can first resonate therein, thereby reducing the divergence of the bass that is otherwise directly sent out from the loudspeaker.

Yet another object of the present invention is to provide a portable over-the-ear miniature sound box device, which provides a second chamber as a sound collecting room (equivalent to a miniature sound box), in which the received sound can resonate again. After resonating twice, sound will be more convergent, and the bass can also be preserved.

To achieve the above objects, the present invention provides a portable over-the-ear miniature sound box device, which comprises a first chamber, a loudspeaker and a second chamber. The first chamber has a first sound output hole thereon. The loudspeaker is disposed in the first chamber. An audio cable is connected to the loudspeaker. Sound from the audio cable resonates in the loudspeaker and is sent into the first chamber and then sent out via the first sound output hole. The second chamber has a sound-receiving hole and a second sound output hole. The sound-receiving hole is connected with the first sound output hole. Sound sent out from the first sound output hole is received by the second chamber via the sound-receiving hole and resonates in the second chamber and is finally sent out via the second sound output hole.

### BRIEF DESCRIPTION OF THE DRAWINGS

The various objects and advantages of the present invention will be more readily understood from the following detailed description when read in conjunction with the appended drawing, in which:

FIG. 1 is a side cross-sectional view of a prior art miniature earphone;

FIG. 2 is a perspective view of the portable over-the-ear miniature sound box device according to a first embodiment of the present invention;

FIG. 3 is an exploded view of the portable over-the-ear miniature sound box device according to the first embodiment of the present invention;

FIG. 4 is a cross-sectional view of the portable over-the-ear miniature sound box device according to the first embodiment of the present invention;

FIG. 5 is a diagram showing how the portable over-the-ear miniature sound box device is hooked on a user's ear according to the first embodiment of the present invention;

FIG. 6 is a cross-sectional view of the portable over-the-ear miniature sound box device according to a second embodiment of the present invention;

FIGS. 7 and 8 are diagrams showing how the portable over-the-ear miniature sound box device is hooked on a user's ear according to the second embodiment of the present invention;

FIG. 9 is a diagram showing how the portable over-the-ear miniature sound box device of the present invention is clipped to a user's ear;

FIG. 10 is a diagram showing how the portable over-the-ear miniature sound box device of the present invention is sleeved onto an eyeglass frame;

FIGS. 11 and 12 are an exploded view and a perspective view of the rotational structure of the portable over-the-ear miniature sound box device of the present invention, respectively;

FIG. 13 is a diagram showing how the rotational structure and the ear-hook device of the portable over-the-ear miniature sound box device of the present invention are connected together;

FIG. 14 is a perspective view of the loudspeaker with a resonance effect in the portable over-the-ear miniature sound box device of the present invention;

FIG. 15 is an exploded view of the loudspeaker with a resonance effect in the portable over-the-ear miniature sound box device of the present invention; and

FIG. 16 is a cross-sectional view of the loudspeaker with a resonance effect in the portable over-the-ear miniature sound box device of the present invention.

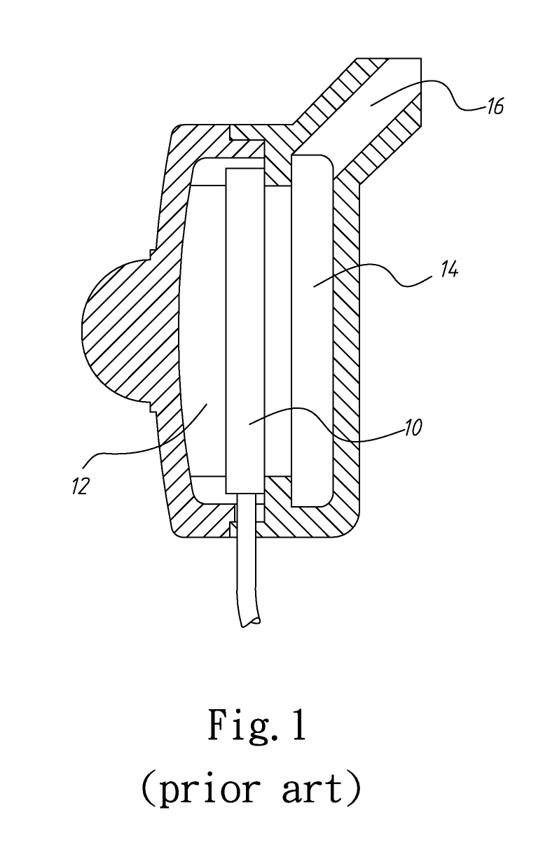

### DETAILED DESCRIPTION OF THE PREFERRED EMBODIMENTS

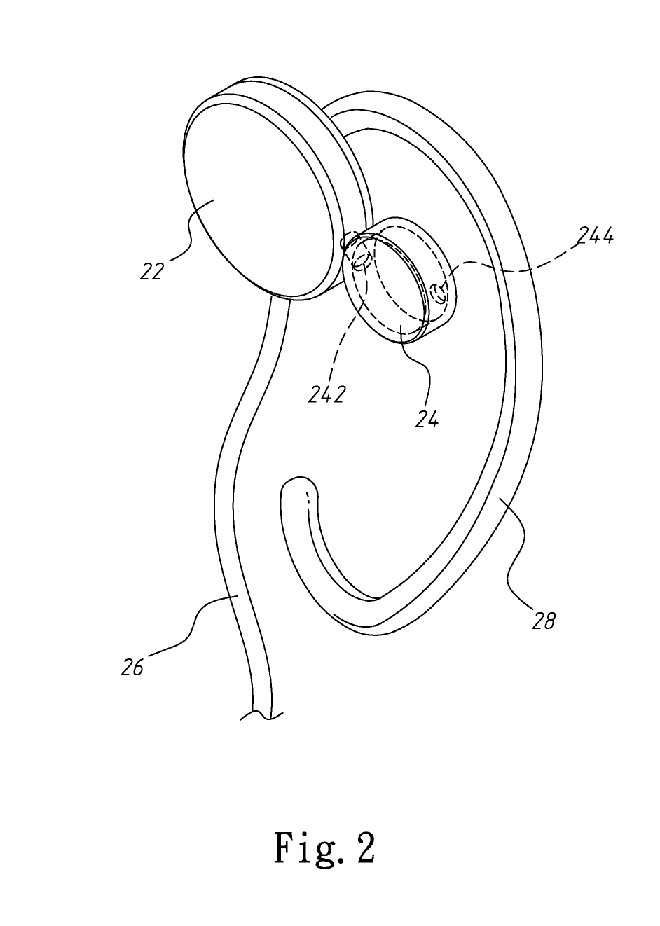

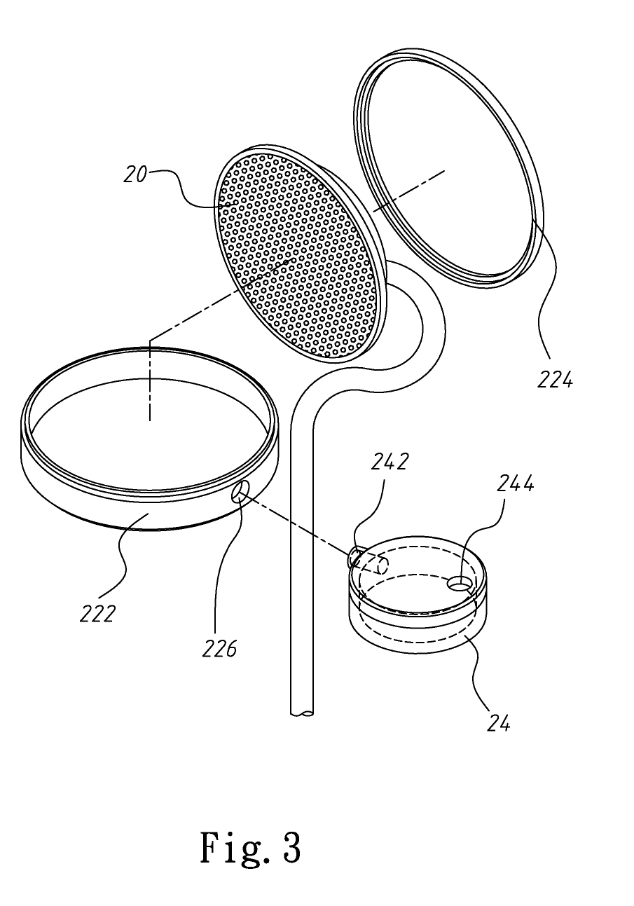

As shown in FIGS. 2 and 3, the present invention provides a portable over-the-ear miniature sound box device, which comprises a loudspeaker 20, a first chamber 22, a second chamber 24, an audio cable 26 and an ear-hook device 28. The loudspeaker 20 is disposed in the first chamber 22. The audio cable is connected to the loudspeaker 20. The first chamber 22 is composed of a front shell body 222 and a rear shell body 224. A first sound output hole 226 is disposed at a side of the first chamber 22. A sound-receiving hole 242 and a second sound output hole 244 are disposed on the second chamber 24. The sound-receiving hole 242 is disposed at a side of the second chamber 24, and is connected with the first sound output hole 226.

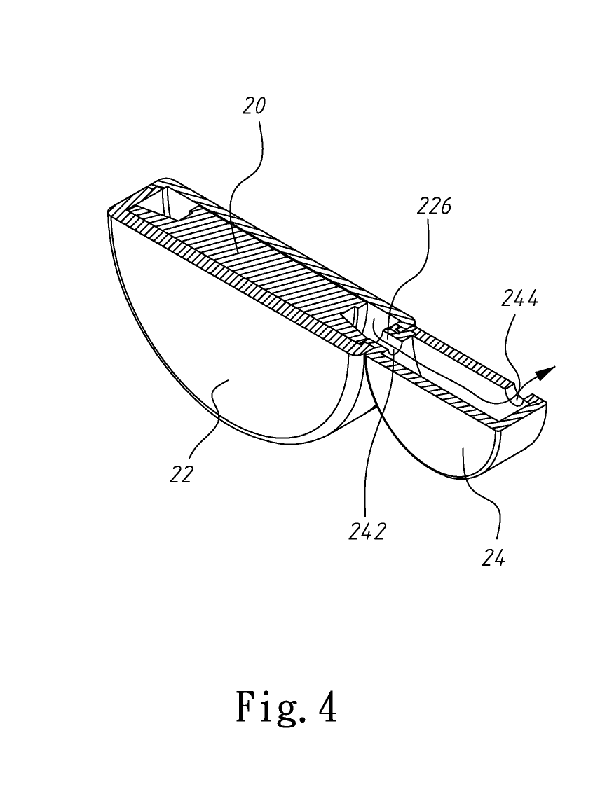

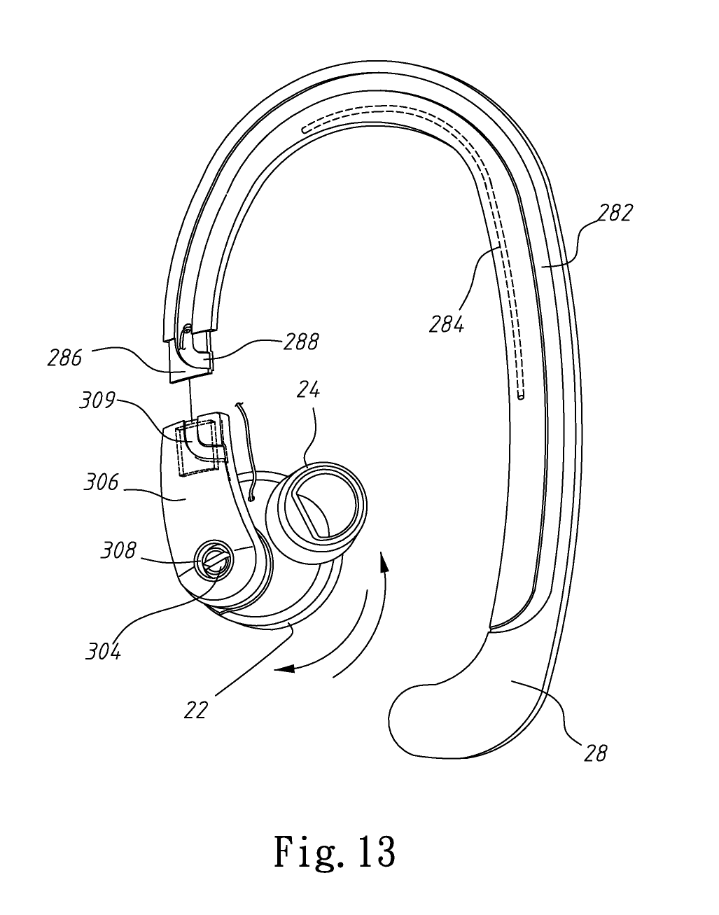

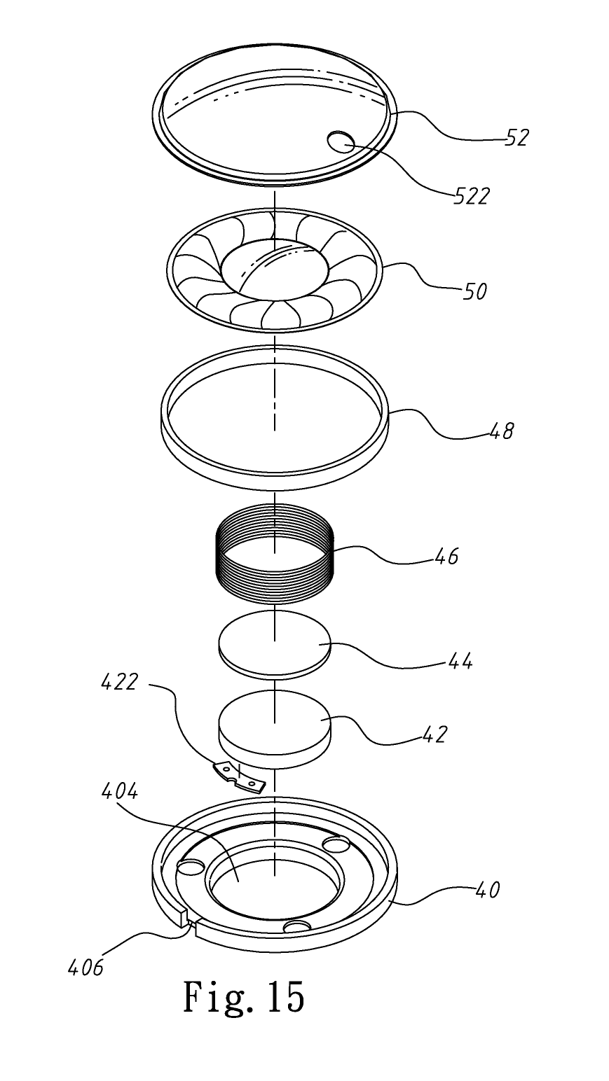

The first chamber 22 is used to load the loudspeaker 20. As shown in FIG. 4, the loudspeaker 20 is clipped between two shell bodies in the first chamber 22 with no gap left. The loudspeaker 20 is bigger than the prior art one and has a sufficient space for resonance so that sound can be directly transmitted from the first chamber 22 into the second chamber 24 after resonance in the loudspeaker 20. The first chamber 22 is not used for resonance. The structure of the loudspeaker 20 will be described in FIGS. 13 to 15 afterwards.

The present invention can apply to a common earphone, an earphone of mobile phone, or an earphone connected to a computer. After a sound signal of a mobile phone, a computer or a walkman is sent out by the audio cable 26 and first resonates in the loudspeaker 20, it is sent into the first chamber 22 and sent out via the first sound output hole 226, and then passes the sound-receiving hole 242 to reach the second chamber 24. The sound signal that has resonated once resonates again in the second chamber 24, and is then sent out via the second sound output hole 244.

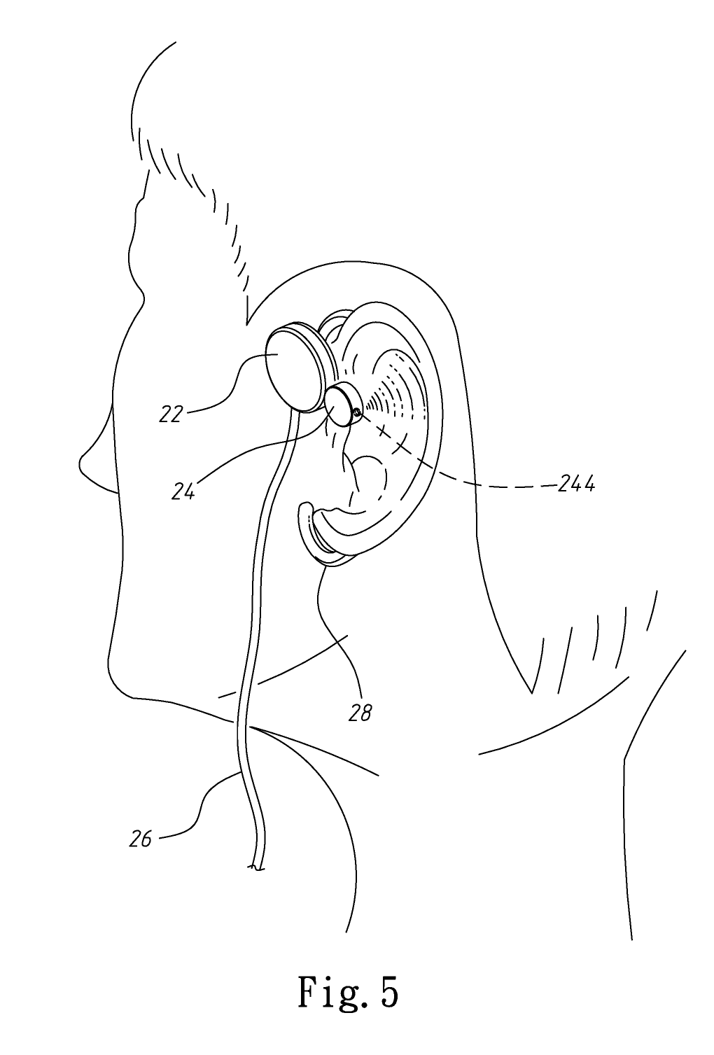

As shown in FIG. 5, the ear-hook device 28 is connected to the first chamber 22, and is used to hook the present invention on a user's ear. The second sound output hole 244 of the second chamber 24 exactly faces the user's ear. Because the treble has a high directionality, it will be directly transmitted to the front of the second sound output hole 244. The bass will be more convergent after resonance twice, and is similarly transmitted into the user's ear just in front of the second sound output hole 244.

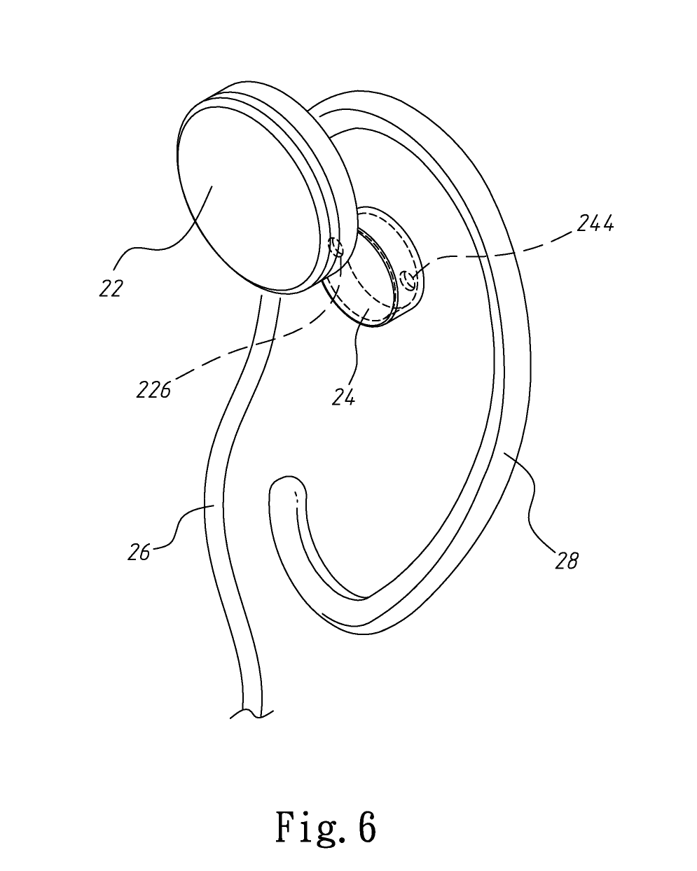

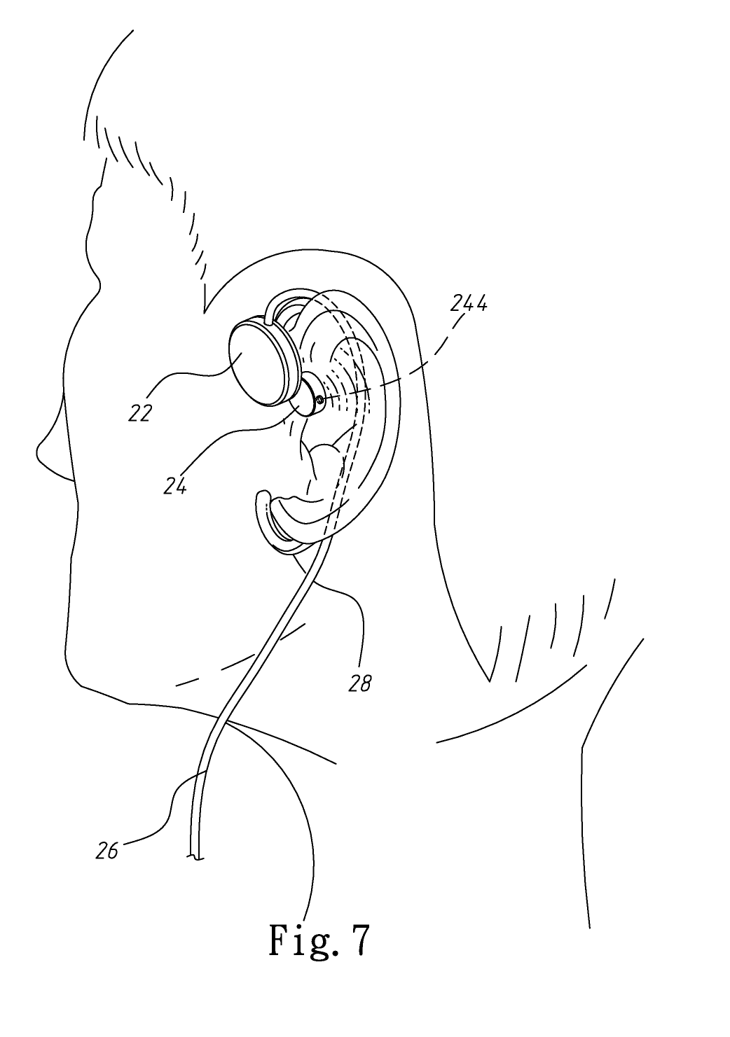

As shown in FIG. 6, in addition that the first chamber 22 and the second chamber 24 are parallel arranged, they can also overlap each other. In this case, the first sound output hole 226 and the sound-receiving hole 242 are disposed on opposite faces of the first chamber 22 and the second chamber 24, respectively. The thickness of the first chamber 22 can thus be reduced to make users more comfortable during wearing. As shown in FIG. 7, the audio cable 26 can be hidden in the ear-hook device 28 and then go around from behind the user's ear.

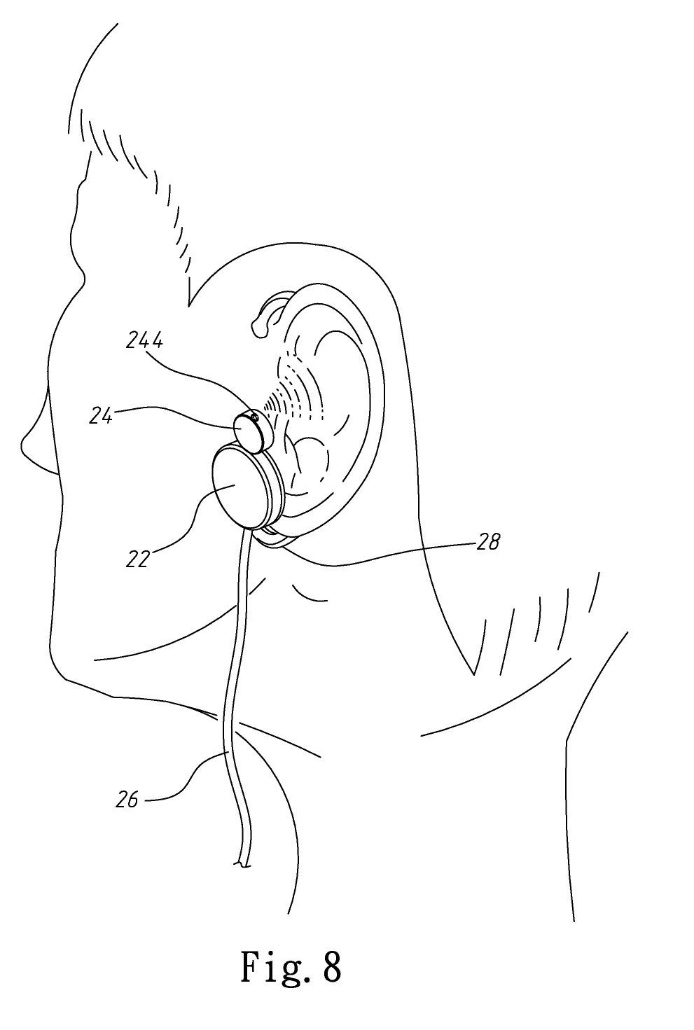

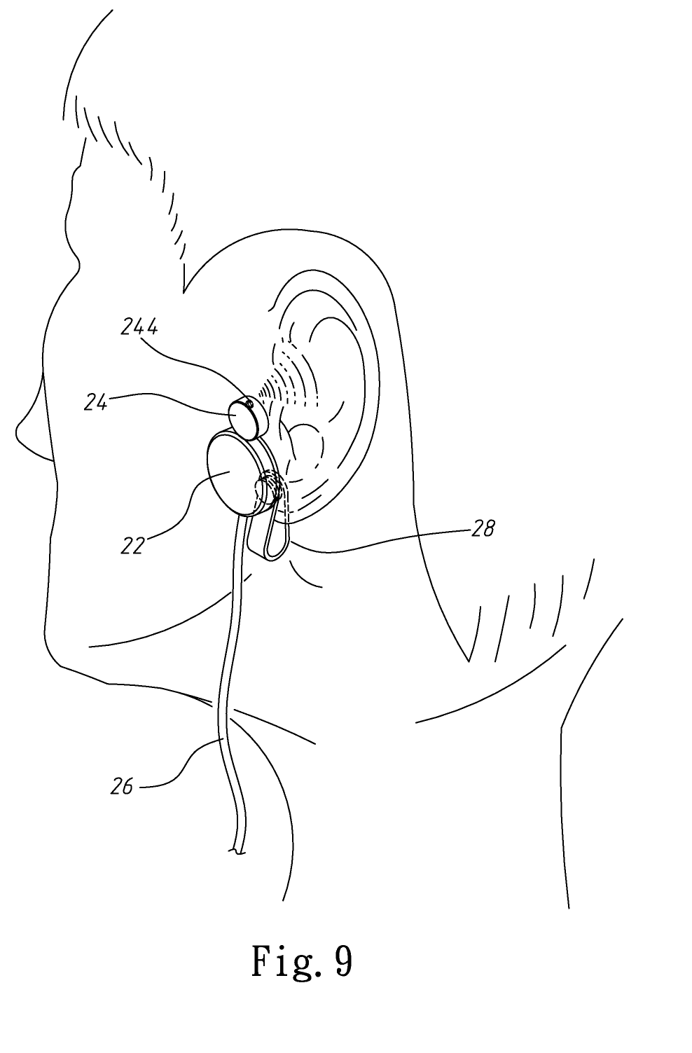

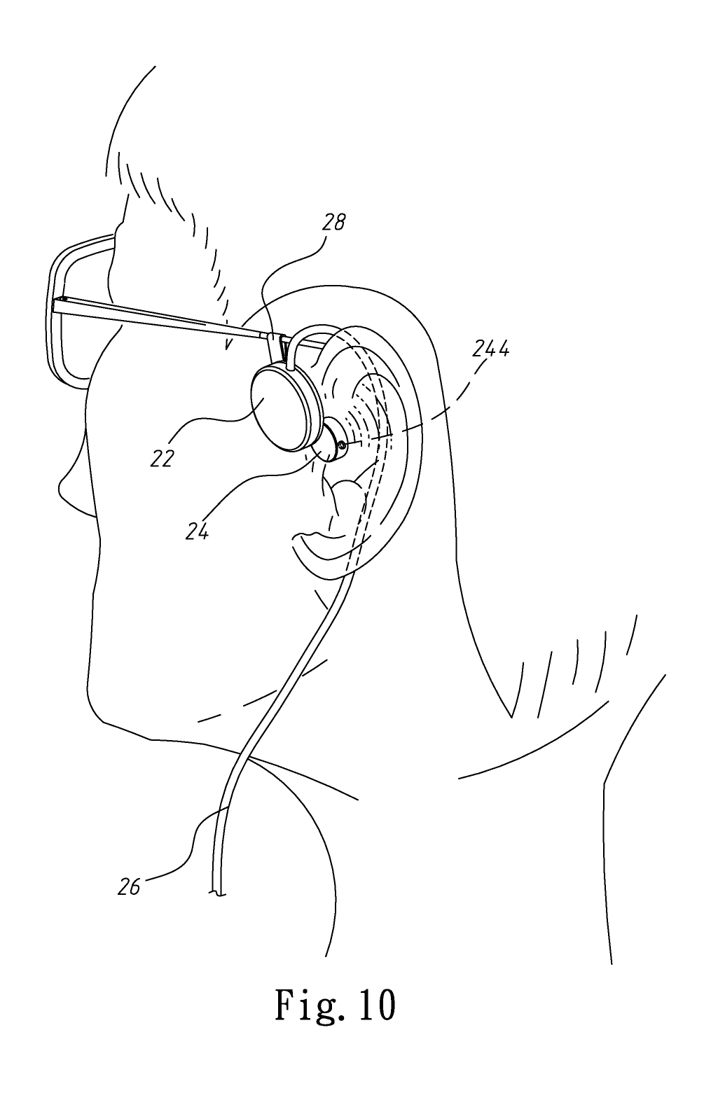

The ear-hook device of the present invention can also be the one shown in FIG. 8, in which the first chamber 22 is connected to the lower part of the ear hook device 28, and the second sound output hole 244 still exactly faces the user's ear. The position of this kind of ear hook device is more inconvenient to users that wear an eyeglass because the ear hook device 28 will get stuck by the eyeglass frame. Therefore, an ear-clipping manner shown in FIG. 9 is proposed. The user clips the portable over-the-ear miniature sound box device of the present invention to his ear as wearing an earring. The ear-clipping manner is not suitable for those with smaller earlobes. The present invention thus also provides an embodiment that won't get stuck by the eyeglass frame, in which the portable over-the-ear miniature sound box device is directly sleeved onto the eyeglass frame, as shown in FIG. 10. The user can sleeve the portable over-the-ear miniature sound box device onto the eyeglass frame or take it off after end of use himself.

The portable over-the-ear miniature sound box device of the present invention can also adopt a wireless reception scheme, in which an induction receiver (not shown) is disposed behind the ear hook device 28 to receive an audio signal, and the audio cable 26 is disposed between the induction receiver and the loudspeaker 20.

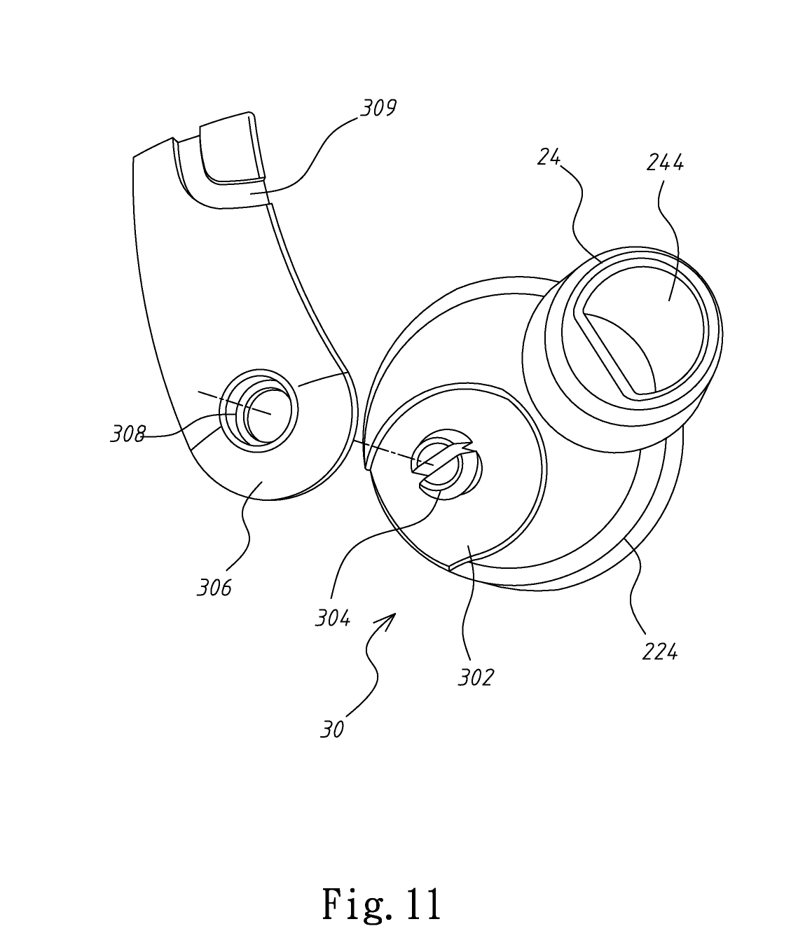

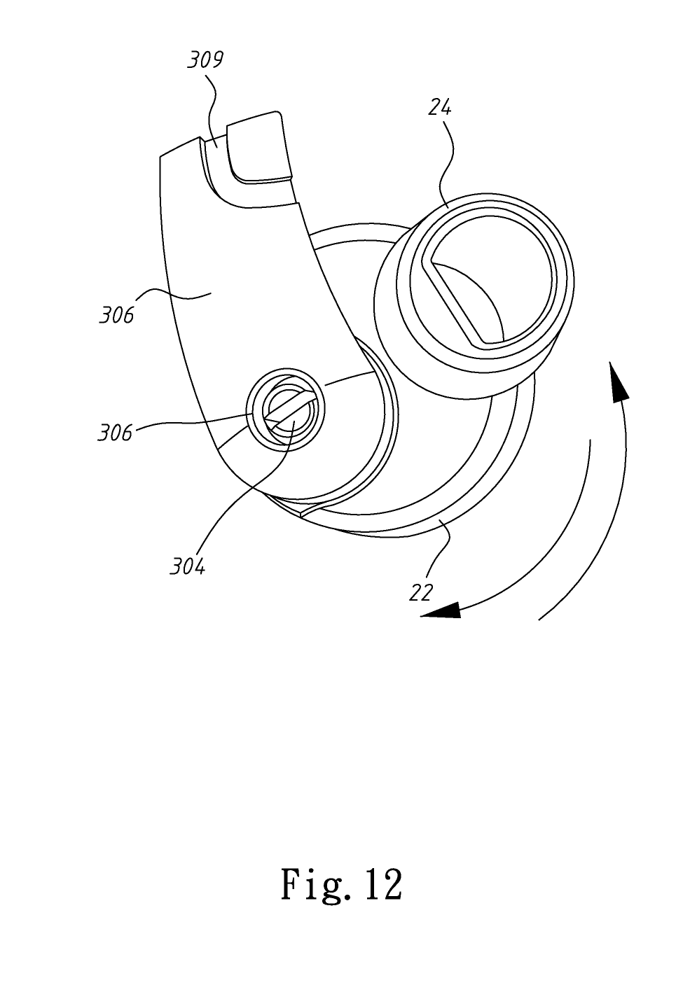

As shown in FIGS. 11 to 13, the portable over-the-ear miniature sound box device of the present invention further comprises a rotational structure 30, which includes a base 302, a latch 304, a link element 306 and a hole 308. The base 302 is disposed on the rear shell body 224 of the first chamber 22. The latch 304 is protrudingly disposed on the base 302. The link element 306 is connected to the ear-hook device 28. The latch can pass the hole 307 and be locked so that the link element 306 can rotate clockwise or counterclockwise with the latch as the pivot. Therefore, the first chamber 22 can rotate clockwise or counterclockwise on the ear-hook device 28 to adjust the second sound output hole to aim at the user's ear. The link element 306 further has a groove 309. The audio cable 26 penetrates from a side opening of the link element into the groove 309. The connection manner of the rotational structure 30 and the ear-hook device 28 is shown in FIG. 13. The ear-hook device 28 is made of soft plastic material. A second groove 282 is formed on a side opening of the ear-hook device to receive the audio cable 26. The ear-hook device 28 uses an insertion piece 286 to plug in the groove 309 and connect the link element 306. A first groove 288 on the insertion piece 286 matches the side opening of the link element 306. The first groove 288 is connected with the second groove 282. The ear-hook device 28 further includes a steel wire 284, which is used to adjust the ear-hook device 28 to be suitable for the profile of the user's ear.

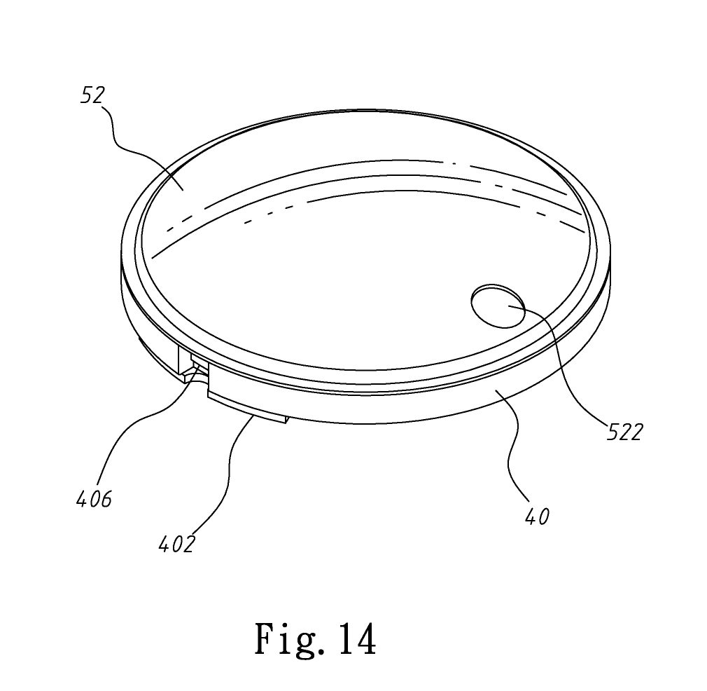

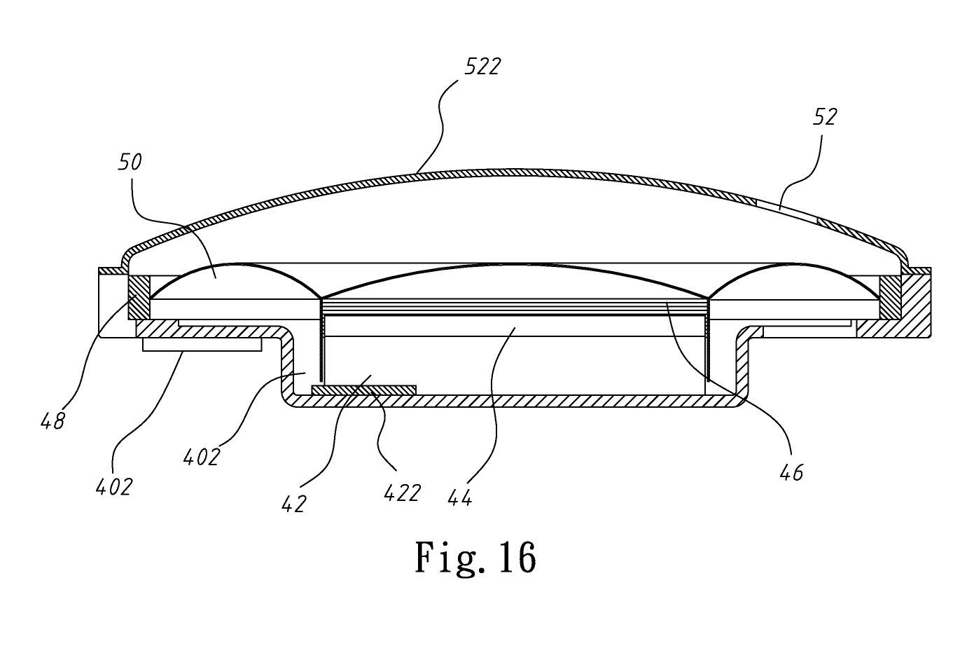

FIGS. 14 to 16 show the structure of the loudspeaker in the portable over-the-ear miniature sound box device of the present invention. The loudspeaker of the present invention has a resonance effect. The loudspeaker comprises a bottom shell 40, a magnet 42, a front plate 44, a coil 46, a metal ring 48, a vibration membrane 50, and a protecting cover 52. An accommodating space 404 protrudes outwards from the center of the bottom shell 40. The magnet 42, the front plate 44 and the coil 46 are circular components of the same diameter, and are placed in order in the accommodating space 404. The coil 46 surrounds the upper half part of the magnet 42 and the front plate 44. Besides, the bottom of the magnet 42 joins a terminal board 422 for soldering two wires thereon. A wire hole 406 is opened on the edge wall of the bottom shell 20 for protruding out of the two wires. The protecting cover 52 can be of a circular arc shape, a square shape, or an arched shape, and joins the edge wall of the bottom shell 40. A resonance space exists between the vibration membrane 50 and the protecting cover 52. The metal ring 48 is sleeved onto the vibration membrane 50. As shown in FIG. 16, the metal ring 48 bulges out of the vibration membrane 50. When the height of the metal ring 48 increases, the resonance space increases therewith. The protecting cover 52 is made of metal, plastic, or acrylic. A third sound output hole 522 is disposed on the protecting cover 52.

When a sound signal is transmitted to the loudspeaker, sound waves will vibrate back and forth within the range encircled by the coil 46 between the front plate 44 and the vibration membrane 50. The sound signal that passes the vibration membrane 50 has an amplified power. The first resonance of sound is accomplished by using the resonance space between the vibration membrane 50 and the protecting cover 52. The sound signal is then sent out via the third sound output hole 522.

The third sound output hole 522 of the loudspeaker of the present invention is designed to be a single sound output hole. The sound signal is collectively emitted out from the third sound output hole 522 after passing the vibration membrane 50, thereby avoiding divergence of the bass and letting the bass be sent farther. Moreover, this design of a single third sound output hole allows the third sound output hole 522 to exactly face the first sound output hole 226 so that the resonant sound can be sent into the second chamber 24 and then directly into the human ear through the directionality of sound. To sum up, the portable over-the-ear miniature sound box device of the present invention allows sound to first resonate in the loudspeaker for reducing divergence of the bass. A second chamber is also provided as a sound collecting room (equivalent to a miniature sound box), in which the received sound can resonate again. After resonance twice, the sound will be more convergent, and the bass can also be preserved. Moreover, because the first resonance occurs in the loudspeaker, the bass will be thicker and more easily heard by human ears, hence solving the problem of easy divergence of the bass.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A portable over-the-ear miniature sound box device comprising:
a first chamber with a first sound output hole;
a loudspeaker disposed in said first chamber, an audio cable being connected to said loudspeaker, sound from said audio cable resonating in said loudspeaker and being sent into said first chamber and then sent out via said first sound output hole; and
a second chamber with a sound-receiving hole and a second sound output hole, said sound-receiving hole being connected with said first sound output hole, sound sent out from said first sound output hole being received by said second chamber via said sound-receiving hole and resonating in said second chamber and being finally sent out via said second sound output hole.

2. The portable over-the-ear miniature sound box device as claimed in claim 1, wherein said first chamber is composed of a front shell body and a rear shell body.

3. The portable over-the-ear miniature sound box device as claimed in claim 1, wherein said first chamber and said second chamber are parallel arranged.

4. The portable over-the-ear miniature sound box device as claimed in claim 1, wherein said first chamber and said second chamber partially overlap each other.

5. The portable over-the-ear miniature sound box device as claimed in claim 3, wherein said first sound output hole and said sound-receiving hole are disposed at a side or a bevel edge of said first chamber and said second chamber, respectively.

6. The portable over-the-ear miniature sound box device as claimed in claim 4, wherein said first sound output hole and said sound-receiving hole are disposed on opposite faces of said first chamber and said second chamber, respectively.

7. The portable over-the-ear miniature sound box device as claimed in claim 1 further comprising an ear-hook device, wherein said ear-hook device is connected to said first chamber and is hooked on an ear of a user, and said second sound output hole exactly faces said ear of the user.

8. The portable over-the-ear miniature sound box device as claimed in claim 7 further comprising a microphone, wherein said microphone is connected to said ear-hook device.

9. The portable over-the-ear miniature sound box device as claimed in claim 7, wherein said first chamber is connected to an upper end of said ear-hook device.

10. The portable over-the-ear miniature sound box device as claimed in claim 7, wherein said first chamber is connected to a lower end of said ear-hook device.

11. The portable over-the-ear miniature sound box device as claimed in claim 1, wherein said first chamber and said second chamber are integrally formed.

12. The portable over-the-ear miniature sound box device as claimed in claim 7 further comprising an induction receiver, wherein said induction receiver is disposed on said ear-hook device and is used to receive wireless transmission signals, and said audio cable is connected to said induction receiver and said loudspeaker.

13. The portable over-the-ear miniature sound box device as claimed in claim 1, wherein said loudspeaker comprises:
a bottom shell with an edge wall at an outer edge thereof, an accommodating space being disposed at a center of said bottom shell, a magnet, a front plate and a coil being placed in said accommodating space;
a vibration membrane of a ringed shape;
a metal ring disposed about a diametrical periphery of said vibration membrane; and
a protecting cover connected with said metal ring, a sound output hole being disposed on said protecting hole so that sound is sent into said first chamber via said sound output hole.

14. The portable over-the-ear miniature sound box device as claimed in claim 13, wherein said protecting cover is of a circular arc shape, a square shape, or an arched shape.

15. The portable over-the-ear miniature sound box device as claimed in claim 13, wherein a resonance space exists between said protecting cover and said vibration membrane.

16. The portable over-the-ear miniature sound box device as claimed in claim 13, wherein said vibration membrane is disposed in said metal ring.

17. The portable over-the-ear miniature sound box device as claimed in claim 7 further comprising a rotational structure, wherein said rotational structure connects said rear shell body of said first chamber and said ear-hook device together so that said first chamber rotate clockwise or counterclockwise on said ear-hook device.

18. The portable over-the-ear miniature sound box device as claimed in claim 17, wherein said rotational structure comprises a link element and a latch, said latch is disposed on said rear shell body, said link element is connected with said ear-hook device, said link element has a hole that penetrates through said latch so that said link element rotate clockwise or counterclockwise with said latch as the pivot.

19. The portable over-the-ear miniature sound box device as claimed in claim 18, wherein said link element further has a groove for receiving said audio cable.
